(19) United States
(12) Patent Application Publication
(10) Pub. No.: US 2007/0189351 A1
(43) Pub. Date: Aug. 16, 2007

(54) Liquid laser with colloidal suspension of lasant nanoparticles

(75) Inventors: Robert R. Rice, Simi Valley, CA (US); Hagop Injeyan, Glendale, CA (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: Northrop Grumman Corporation

(21) Appl. No.: 11/354,662

(22) Filed: Feb. 15, 2006

(51) Int. Cl. H01S 3/20; H01S 3/093

(52) U.S. Cl. 372/51; 372/72

(57) ABSTRACT

A laser utilizing a liquid based lasing medium, comprising a colloidal suspension of selected solid state lasant nanoparticles in a selected liquid. Use of sufficiently small lasant nanoparticles allows relaxation of the requirement to match the refractive indices of the lasant and the liquid because the nanoparticles have a desirably low scattering loss even when the refractive indices are not perfectly matched. Therefore, higher laser powers are achievable without unwanted thermally induced birefringence and depolarization.

### BACKGROUND OF THE INVENTION

This invention relates generally to high power lasers and, more particularly, to high power lasers that utilize a liquid gain medium. Much progress has been made in the design and construction of solid state lasers for operation at high powers. A well known drawback of solid state lasers is that they suffer from thermo-optic distortions of the laser medium, and these distortions ultimately limit the amount of diffraction limited power that can be generated. The distortions include spatial variations of refractive index and stress induced birefringence by temperature gradients with the laser medium.

It is also known that these fundamental problems with solid state lasers could be minimized or completely avoided by the use of a gain medium having a liquid form. Patent Application No. US 2003/0161364 by Michael D. Perry, entitled “Laser Containing a Slurry,” generally describes such a liquid laser, in which the gain medium comprises portions of a solid state material suspended within a fluid having a refractive index substantially similar to that of the solid state portions. This slurry is circulated between an active laser volume and a cooling system. The slurry, therefore, functions both as the gain medium and as a coolant.

The principal drawback of this approach as described by Perry is that there must be a substantial match of refractive index between the solid state particles and the liquid medium. Typical solid state laser materials have refractive indices in the range of approximately 1.45 to 2, which unfortunately requires the use of exotic, toxic, or environmentally unfriendly fluids to prepare the slurry. If the index match is not close, the Mie scattering losses are substantial. For example, if spherical particles 0.5 micron (0.5 μm) in diameter and having a refractive index of 1.5 (Nd:Glass at a 1064 nm wavelength) are suspended in water (refractive index=1.33), they will scatter with a scattering coefficient of 179 cm⁻¹ if there is one particle per cubic micron. This is only about 6% volume loading, so scattering is severe for particles of this size. Hence, the index match between the lasant particle and the carrier fluid must be very good for this prior art technology to be successfully employed.

Accordingly, although the use of a slurry as a lasing and cooling medium offers attractive advantages, there is still need for improvement because of the requirement for close index matching of the solid state lasant particles and the liquid in which the particles are suspended. The present invention addresses this need.

### SUMMARY OF THE INVENTION

The present invention resides in a liquid laser in which nanoparticles of a solid state lasant material are colloidally suspended in a liquid. The nanoparticles result in only insubstantial scattering of light, even when there is a substantial mismatch of refractive indices of the solid state and liquid material. Therefore, the advantages of a liquid-based lasing medium are more fully achieved and, in particular, higher power levels can be attained without the disadvantage of stress induced birefringence and polarization associated with solid state lasers.

Briefly, and in general terms, the laser device of the invention comprises a laser cavity formed to encompass a vessel containing a lasing material that is a colloidal suspension of lasant nanoparticles in a liquid; means for supplying laser pump power to the vessel; means for circulating the liquid and the suspended lasant nanoparticles for cooling purposes; and means for coupling a laser beam out of the laser cavity. The liquid is selected for its desired physical and optical properties but without necessarily matching its refractive index with that of the lasant nanoparticles.

The lasant nanoparticles are of a material selected to produce lasing at one or more wavelengths of interest. In particular, the lasant nanoparticles may be of at least two different materials, selected to produce lasing at two or more wavelengths of interest.

More specifically, the liquid is selected to be transparent at the wavelength or wavelengths of interest, to be chemically stable, and to have surface tension properties consistent with maintenance of a colloidal suspension in which settling or clumping of the lasant nanoparticles is minimized. The liquid may include a surfactant to enhance its surface tension properties and minimize clumping of the lasant nanoparticles.

In accordance with one aspect of the invention the lasant nanoparticles include some inert nanoparticles that have a refractive index larger than that of the liquid. Thus, the effective refractive index of the colloidal suspension is increased, allowing the use of larger lasant nanoparticles while still maintaining acceptable scattering losses.

In one specific embodiment of the invention, the lasant nanoparticles have an average size of approximately 10 nm. By way of further example, the lasant nanoparticles are of neodymium oxide (Nd2O3) and the liquid is water or a mixture of water and ethylene glycol.

The laser vessel may be of rectangular or circular cross section without departing from the intended scope of the invention.

In some applications of the invention, the compositions of the lasant nanoparticles are selected to provide a wide gain linewidth, allowing amplification of short laser pulses.

It will be appreciated form the foregoing that the present invention represents a significant advance in the field of high power lasers. In particular, the use of a colloidal suspension of nanoparticles of a lasant material in a liquid provides all the advantages of a liquid lasing medium, without requiring exact matching of liquid and lasant refractive indices. Other aspects and advantages of the invention will become apparent from the following more detailed description, taken in conjunction with the drawings.

### BRIEF DESCRIPTION OF THE DRAWINGS

FIG. 1 is a graph showing the variation of extinction (due principally to scattering) with particle diameter.

FIG. 2 is a schematic diagram showing the principal components of a liquid laser system in accordance with the present invention.

FIG. 3A is a cross-sectional view of the laser cavity of the system of FIG. 1, taken substantially along the line 3-3.

FIG. 3B is an alternative cross-sectional view of the laser cavity, also taken along the line 3-3.

### DETAILED DESCRIPTION OF THE INVENTION

As shown in the drawings for purposes of illustration, the present invention is concerned with lasers, and in particular with the use of a liquid to contain a lasing medium. A prior proposal to employ a slurry of a fluid and suspended particles of a solid state lasant have required very close matching of the refractive indices of the fluid and lasant particles. Without close matching of the indices, scattering losses can be high enough to render the arrangement impractical.

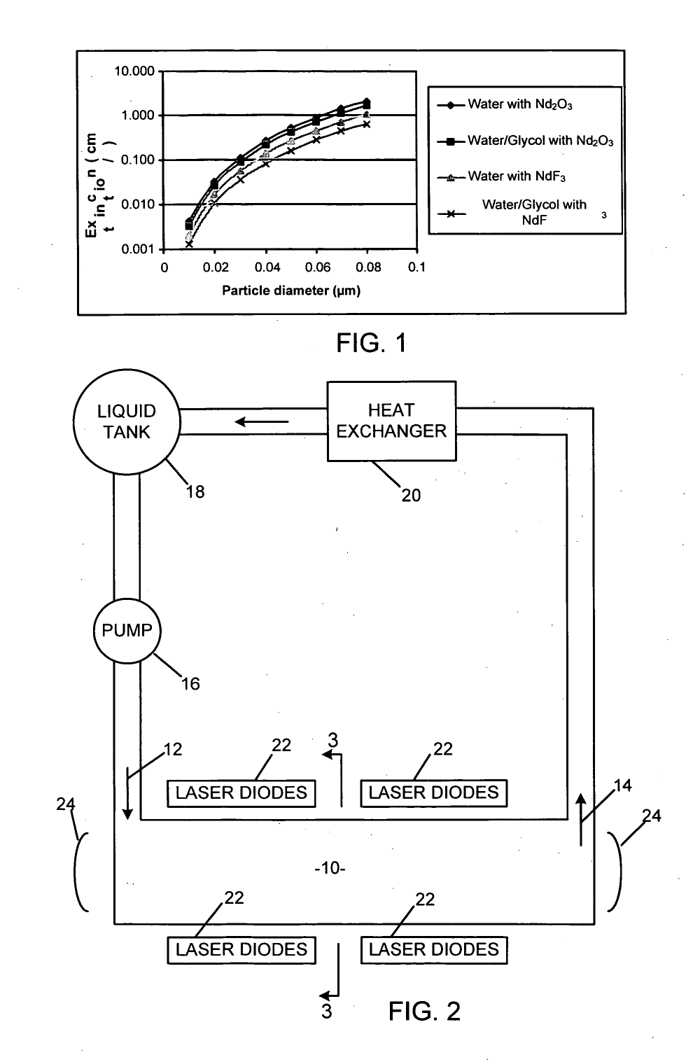

In accordance with the present invention, very small particles (nanoparticles) of the dispersed lasant are used and the scattering level is thereby reduced to an acceptable level, regardless of the degree of index mismatch between the particles and the carrier fluid. The particle size required for this beneficial effect depends upon the degree of mismatch, but will reliably occur for particles of the order of 10 nm or so. FIG. 1 shows this relationship, which based on a known principle that the degree of Mie scattering is dependent on particle size. The effective refractive index of the mixture will be impacted by the presence of the sub-scattering nanoparticles, potentially significantly, which can be used to advantage, as further discussed below.

The possible configurations for laser devices employing the present invention are quite varied, including cylindrical, slab and disk shaped lasing volumes. Diode pumping can be collinear or transverse depending upon the design of the resonator or amplifier. FIG. 2 shows one possible form of a laser system in accordance with the invention. The system comprises a laser cavity or chamber 10 through which a colloidal suspension of the type described is circulated. The liquid enters the chamber 10 as indicated by the arrow 12 and leaves as indicated by the arrow 14. Liquid circulation components include a pump 16 a liquid reservoir or tank 18 and a heat exchanger 20 of appropriate design. The latter may simply radiate heat to the surroundings or may involve heat exchange with another fluid. Laser diodes arrays 22 are positioned adjacent to the chamber 10 and perform the same pumping function for which similar arrays are used in solid state laser systems. As indicated diagrammatically by the concave mirrors 24, at least a portion of the chamber 10 encloses a laser cavity. Depending on the specific design of the system, the chamber may be part of a laser resonator or a laser amplifier. It is further contemplated that multiple chambers of the same construction as the chamber 10 may be arrayed to provide higher power outputs.

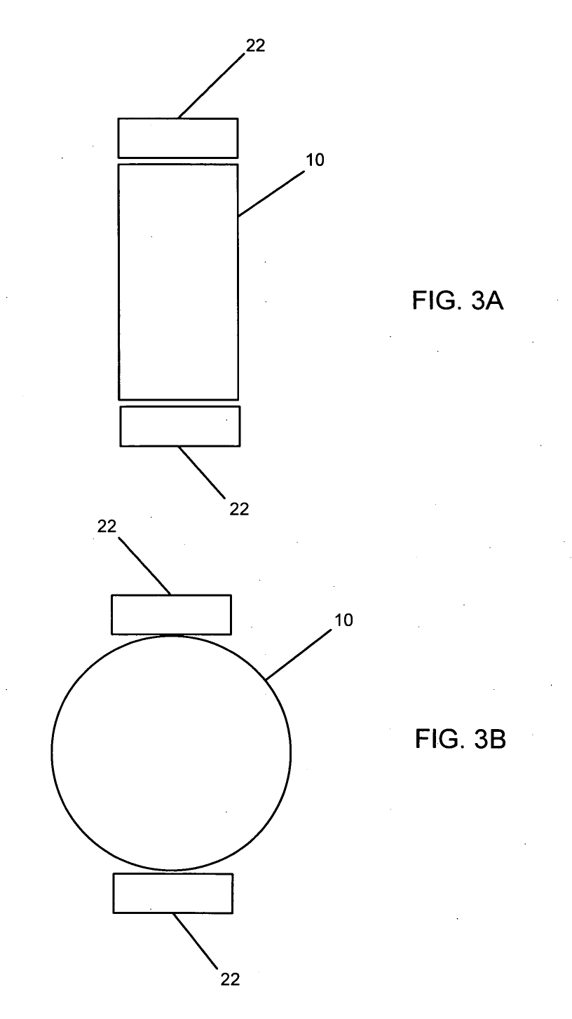

The chamber 10 in which lasing takes place may be rectangular in cross section, as depicted in FIG. 3A, or may be circular in cross section, as depicted in FIG. 3B. In the development of solid state lasers, rectangular slabs of solid state material have been preferred because they avoid the thermally induced stresses associated with cylindrical rod lasers, and also minimize the resultant thermally induced birefringence and depolarization. A cylindrically shaped liquid laser would not, however, be subject to the stresses and associated thermally induced properties of cylindrical rod lasers. Flow through the chamber 10, while principally axial in direction may also include a deliberately induced vortex flow to reduce the possibility of transverse thermal gradients within the chamber.

The nanoparticles can be of mixed composition, so long as the sizes are all sufficiently small to mitigate Mie scattering. Thus, the slurry medium could be used to amplify two or more wavelengths through selection of the lasant particle compositions. This could be used to significant advantage in some applications. If the compositions of the lasant nanoparticles are selected so as to provide an extraordinarily wide gain linewidth, amplification of very short pulses is possible. In this situation, a beam collapse event that would prove catastrophic for a conventional solid-state laser medium will be self-healing in this liquid laser medium. With regard to short pulses, some carrier fluids, such as liquid carbon disulfide (CS₂) exhibit large nonlinear effects, such as stimulate Brillouin scattering (SBS), self-phase modulation (SPM), and four wave mixing (FWM), and are actually used in cells externally to broaden the spectrum of pulses from short pulse lasers. Using such carrier fluids with appropriate mixtures of lasant nanoparticles can enable production of extremely short pulses. Further, as mentioned above, inert nanoparticles can be loaded into a carrier fluid so as to change its refractive index in a useful way. The addition of, for example, high index nanoparticles to a carrier fluid having an index lower than the lasant particles could raise its effective index and enable the use of larger lasant particles with acceptable scattering, were that to prove advantageous.

The selection of a suitable liquid for suspension of the nanoparticles is fortunately much wider if one does not have to be so concerned about matching of indices of refraction. The liquid should, however, have certain desired optical and physical properties that render it suitable for a particular application. First, the liquid should be optically transparent at one or more wavelengths of interest. It should also be chemically stable and have good thermal properties; in particular the refractive index should remain substantially constant with temperature. It is also most important, of course, that the liquid should support the selected nanoparticles in a colloidal suspension, without settling or clumping of the particles. In this regard, the surface tension of the liquid is an important property, which may be enhanced by the addition of a suitable surfactant. The liquid is also selected for its refractive index, but this property is not as critical as it would be if larger solid state particles were being used. Since the vessel 10 acts both as a container and an optical waveguide, the refractive index of the liquid must be greater than that of the chamber walls, but this is not difficult to achieve.

The preparation and dispersion of lasant nanoparticles can be carried out by a variety of processes known to those skilled in the art. For example, neodymium oxide (Nd₂O₃) nanoparticles can be obtained commercially at low cost from companies such as Inramat® Corporation, Farmington Conn. Nanoparticles down to 80 nm are available off the shelf, and smaller sizes are available by ordering special processing.

The question of particle size needed can be addressed by using readily available Mie scattering models. One such model is available as a calculator found through the Internet at http://omlc.ogi.edu/software/mie/ and this was used to calculate the extinction coefficients for various examples of a dispersed nanoparticle medium. These coefficients are plotted in FIG. 1, which shows a graph of extinction as a function of particle size for two potential lasing materials: neodymium oxide (Nd₂O₃) and neodymium fluoride (NdF₃), in two carrier fluids: water (n=1.33) and an ethylene glycol/water mixture (n=1.41), and at a lasant to carrier volume ratio of 1%. The data for Nd₂O₃ nanoparticles are plotted in the two uppermost curves, and the data for NdF₃ nanoparticles are plotted in the two lowermost curves. The graphs show that all four combinations have losses under 0.5%/cm when the particle size is less than 10 nm. The NdF₃/water/glycol combination shows an extinction loss approaching 0.1%/cm, which is less than that found in ordinary solid-state laser crystalline media such as neodymium:yttrium-aluminum-garnet (Nd:YAG), which has an extinction coefficient of approximately 0.2%/cm.

It will be appreciated from the foregoing that the present invention represents a significant advance in the field of high power lasers having a liquid based lasing medium. In particular, the invention allows for operation of a laser device at higher powers than solid-state lasers, without concern for thermally induced birefringence and depolarization. Moreover, by using a colloidal suspension of nanoparticles of a solid state material in a suitable liquid, the invention eliminates the need for substantially matching the indices of refraction of the liquid and the lasant particles. It will also be appreciated that although a number of embodiments of the invention have been illustrated and described, various modifications may be made without departing from the spirit and scope of the invention. Accordingly, the invention should not be limited except as by the appended claims.

1. A high power laser, comprising:
a laser cavity formed to encompass a vessel containing a lasing material that is a colloidal suspension of lasant nanoparticles in a liquid;
means for supplying laser pump power to the vessel;
means for circulating liquid and suspended lasant nanoparticles for cooling purposes; and
means for coupling a laser beam from the laser cavity;
wherein the liquid is selected for its desired physical and optical properties but without necessarily matching its refractive index with that of the lasant nanoparticles.

2. A high power laser as defined in claim 1, wherein:
the lasant nanoparticles are of a material selected to produce lasing at one or more wavelengths of interest.

3. A high power laser as defined in claim 2, wherein:
the lasant nanoparticles are of at least two different materials, selected to produce lasing at more than one wavelength of interest.

4. A high power laser as defined in claim 2, wherein:
the liquid is selected to be transparent at the wavelength of interest, to be chemically stable and to have surface tension properties consistent with maintenance of a colloidal suspension in which settling or clumping of the lasant nanoparticles is minimized.

5. A high power laser as defined in claim 4, wherein:
the liquid includes a surfactant to enhance surface tension and minimize clumping of the lasant nanoparticles.

6. A high power laser as defined in claim 4, wherein:
the lasant nanoparticles include some inert nanoparticles that have a refractive index larger than that of the liquid; and
the effective index of the colloidal suspension is thereby increased, allowing the use of larger lasant nanoparticles while still maintaining acceptable scattering losses.

7. A high power laser as defined in claim 4, wherein:
the lasant nanoparticles have an average size of approximately 10 nm.

8. A high power laser as defined in claim 4, wherein:
the lasant nanoparticles are of neodymium oxide (Nd₂O₃); and
the liquid is water or a mixture of water and ethylene glycol.

9. A high power laser as defined in claim 1, wherein:
the laser vessel has a rectangular cross section as viewed in the lasing direction.

10. A high power laser as defined in claim 1, wherein:
the laser vessel has a circular cross section as viewed in the lasing direction.

11. A high power laser as defined in claim 1, wherein:
the compositions of the lasant nanoparticles are selected to provide a wide gain linewidth, allowing amplification of short laser pulses.
